(19) United States
(12) Patent Application Publication
(10) Pub. No.: US 2014/0015356 A1
(43) Pub. Date: Jan. 16, 2014

(54) SEGMENTED ELECTRIC MACHINE CORE SECURED WITH BELT AND METHOD OF MANUFACTURE

(71) Applicant: Remy Technologies, LLC, Pendleton, IN (US)

(72) Inventor: Bradley D. Chamberlin, Pendleton, IN (US)

(21) Appl. No.: 13/938,522

(22) Filed: Jul. 10, 2013

Related U.S. Application Data
(60) Provisional application No. 61/670,200, filed on Jul. 11, 2012.

(51) Int. Cl. H02K 1/18; H02K 9/22; H02K 15/02; H02K 1/28

(52) U.S. Cl. CPC H02K 1/18; H02K 1/28; H02K 9/22; H02K 15/02
USPC 310/64; 310/216.074; 310/216.045; 310/216.113; 29/596

(57) ABSTRACT

An electric machine having a segmented core wherein the core includes a plurality of core segments. The segments are secured together with a belt member that substantially encircles the core segments but does not extend the full axial length of the segments. In some embodiments, the individual segments include a recess on their outer radial surface in which the belt member is positioned. A method of assembling an electric machine having a segmented core is also disclosed. Coils are wound about the poles of a plurality of segments. After forming the coils on the segments, the segments are joined together with a belt member wherein the belt member does not extend the full axial length of the core segments and is positioned between the two axial ends of the core assembly.

### CROSS REFERENCE TO RELATED APPLICATIONS

This application claims priority under 35 U.S.C. 119(e) of U.S. provisional patent application Ser. No. 61/670,200 filed on Jul. 11, 2012 entitled SEGMENTED ELECTRIC MACHINE CORE SECURED WITH BELT the disclosure of which is hereby incorporated herein by reference.

### BACKGROUND

The present invention relates to electric machines and, more particularly, to electric machines having a segmented core.

There is an increasing demand for greater efficiency and improved power and torque densities in electric machines. Conventional electric machines often have a stator core formed out of stacked laminations with inwardly projecting poles or teeth defining slots between the poles. In many electric machines, e.g., brushless AC and DC electric machines, coils are wrapped about individual poles and the copper wire forming the coils fill the slots. When the stator core is a single structure forming a complete ring, access to the slots presents manufacturing difficulties which limit the density of the copper wire achievable within each of the slots. The density of the wires within the slots has a direct impact on the efficiency and power and torque densities of the resulting electric machine with higher fill factors providing enhanced performance characteristics.

One known method of increasing the slot fill factor of an electric machine is to use a segmented stator core. Instead of winding coils around the poles of a unitary one piece stator core, segmented stator cores are manufactured by first forming a plurality of stator core segments having one or more stator poles out of a stack of laminations. Wire coils are then wound about the stator poles. After the coils are completed, the core segments with coils thereon are assembled into a ring and joined together to form the stator assembly. The ability to wind coils around the stator poles of the core segments without adjacent core segments inhibiting access during the winding process allows segmented stator cores to realize a higher slot fill density and the enhanced performance characteristics provided thereby. Some known segmented cores use core segments having only a single pole while others use core segments having multiple poles.

Generally, a segmented stator core must be varnished at some point after the coils have been placed on the stator segments. The varnish provides electrical insulation and also limits relative movement of the individual wires forming the coils. The varnish can be applied to individual stator segments after the coil has been wound thereon. Alternatively, the entire stator assembly can be varnished after the individual segments have been secured together into a complete stator assembly. Each of these options has its drawbacks. Varnishing each of the individual stator segments before assembly increases the number of varnishing procedures which is undesirable.

When the individual segments are assembled together, they are typically installed into a housing that fully encircles and extends the full axial length of the stator assembly. When varnishing the stator after assembly, the housing will also generally receive a coating of varnish. Such housings often perform additional functions and have numerous features such as cooling channels, small holes and other complex features. Varnish must either be removed from many of these features in a subsequent manufacturing step or some additional step, such as masking the features, must be taken to avoid applying the varnish to the housing features during the varnishing process. Thus, the removal or avoidance of varnish on complex features of the housing presents an undesirable attribute of varnishing the stator assembly after the individual stator segments have been secured together to form the stator assembly.

FIGS. 7 and 8 illustrate a prior art segmented stator assembly wherein a plurality of stator segments 136 are joined together in a ring with a sleeve 138 that extends the full axial length of the stator core segments. A bus bar 172 which electrically couples the windings located on the stator segments 136 is also shown in FIG. 7.

While electric machines having segmented cores can be manufactured using known manufacturing techniques, there remains a need for improving the design and manufacturing methods for electric machines having segmented cores.

### SUMMARY

The present application discloses an improved segmented core design for an electric machine which facilitates the efficient manufacture of the completed segmented core assembly.

The invention comprises, in one form thereof, an electric machine that includes a stator assembly and a rotor assembly wherein at least one of the assemblies includes a core. The core includes a plurality of core segments defining an axial length. The core segments are secured together in a core assembly with at least one belt member. The belt member substantially circumscribes the plurality of core segments and has an axial dimension that is less than the axial length of the core segments. The core assembly defines first and second axial ends and the belt member is disposed between and spaced from the first and second axial ends of the core assembly.

In some embodiments, the at least one belt member is a single belt member disposed substantially equidistantly between the first and second axial ends. The core segments may be advantageously formed out of a plurality of stacked lamina with the belt member engaging only selected ones of the plurality of staked lamina. For example, the selected lamina which engage the belt member can be used to define a recess in which the belt member is seated.

In still other embodiments, the axial height of the belt member is, advantageously, no more than approximately 5% of the axial distance between the first and second axial ends. In such an embodiment, the core assembly may be a stator core which defines a central bore for receiving the rotor assembly. The belt member can be a single belt formed out of a metal material, completely encircle the plurality of core segments when secured in the core assembly, and be disposed substantially equidistantly between the first and second axial ends. The core segments can be configured to have a single pole extending from a circumferentially extending yoke portion with each of the yoke portions being engaged with the yoke portions of adjacently positioned core segments when the plurality of core segments are secured in the core assembly and with a wire coil being wrapped about each of the poles. Such core segments can be formed out of a plurality of stacked lamina with selected ones of the plurality of lamina defining a recess for receiving the belt member. The electric machine may also include a housing member defining a fluid passage for circulating a coolant wherein the core assembly is disposed within the housing member with an outer radial surface of each of the yoke portions being engaged with the housing member to thereby transfer heat from the core assembly to the housing.

The invention comprises, in another form thereof, a core assembly for an electric machine. The core assembly includes a plurality of core segments defining an axial length. The core segments are secured together in a core assembly with a belt member which substantially circumscribes the plurality of core segments and has an axial dimension that is less than the axial length of the core segments. The core assembly defines first and second axial ends and the belt member is axially disposed entirely between the first and second axial ends of the core assembly.

The invention comprises, in still another form thereof, a method of manufacturing an electric machine having at least one segmented core. The method includes forming a plurality of core segments wherein each of the core segments is formed by stacking a plurality of lamina; winding a wire coil about each of the core segments; and securing the plurality of core segments in a core assembly with a belt member that substantially circumscribes the plurality of core segments. The core assembly defines first and second axial ends and the belt member is axially disposed entirely between the first and second ends and has an axial height less than an axial distance between the first and second ends. The method also includes installing the core assembly in a housing member after securing the plurality of core segments with the belt member.

In some embodiments, the method includes applying a varnish to the core assembly after securing the plurality of core segments together with the belt member. In such embodiments, the method may advantageously further include removing varnish from the outer radial surfaces of the core segments; providing the housing member with a fluid channel for circulating a coolant; and installing the core assembly in the housing member with the outer radial surface of the core segments engaged with the housing member.

In some embodiments, the belt member remains positioned on the core assembly after completing assembly of the electric machine. In other embodiments, the belt member is removed from the core assembly during the installation of the core assembly into the housing member.

In still other embodiments of the method, the core assembly is a stator core and has a central bore and each of the core segments define a circumferentially extending yoke portion having a single pole extending radially therefrom, the wire coil of each core segment being wound about the pole. In such an embodiment the method may further include engaging the yoke portions of each of the core segments with the yoke portions of adjacent core segments when securing the core segments with the belt member and positioning the belt member in a recess defined by an outer radial surface of the plurality of core segments and circumscribing the core assembly. The method may additionally include providing the housing member with a fluid channel for circulating a coolant; installing the core assembly in the housing member with the outer radial surface of the core segments engaged with the housing member; and positioning a rotor assembly in the central bore.

### BRIEF DESCRIPTION OF THE DRAWINGS

The above mentioned and other features of this invention, and the manner of attaining them, will become more apparent and the invention itself will be better understood by reference to the following description of an embodiment of the invention taken in conjunction with the accompanying drawings, wherein:

FIG. 1 is a perspective view of a laminated stator segment.

FIG. 2 is a perspective view of a stator segment with a coil mounted thereon.

FIG. 3 is a perspective view of a segmented stator assembly.

FIG. 4 is a top view of belt for securing a segmented stator assembly.

FIG. 5 is a schematic cross sectional view of an electric machine with a belted segmented stator assembly.

FIG. 6 is a partial schematic cross sectional view of a stator segment.

FIG. 7 is an exploded view of a prior art segmented stator assembly.

FIG. 8 is a perspective view of a prior art segmented stator assembly.

Corresponding reference characters indicate corresponding parts throughout the several views. Although the exemplification set out herein illustrates an embodiment of the invention, in one form, the embodiment disclosed below is not intended to be exhaustive or to be construed as limiting the scope of the invention to the precise form disclosed.

### DETAILED DESCRIPTION

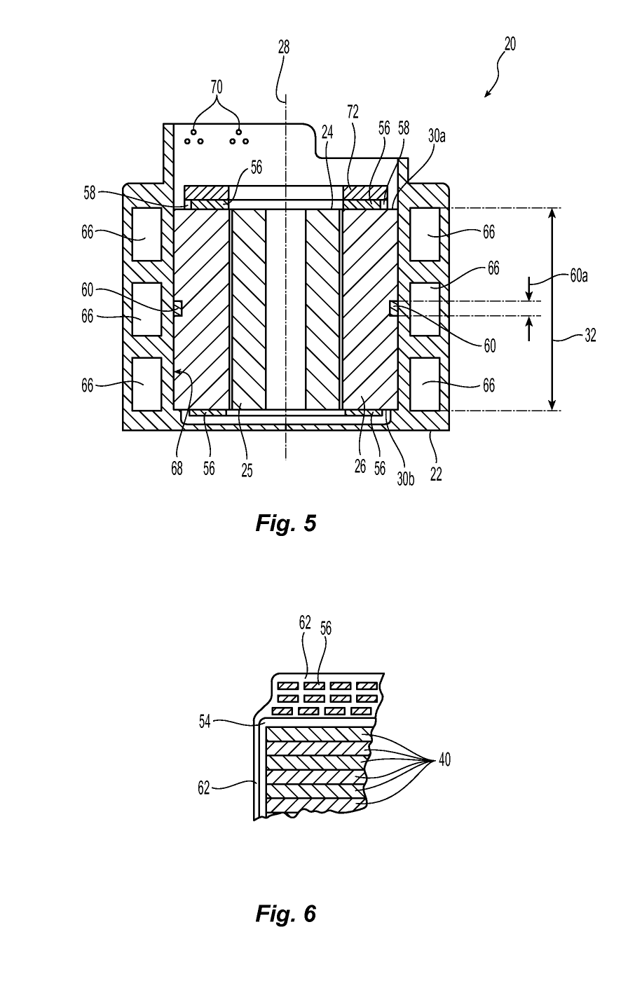

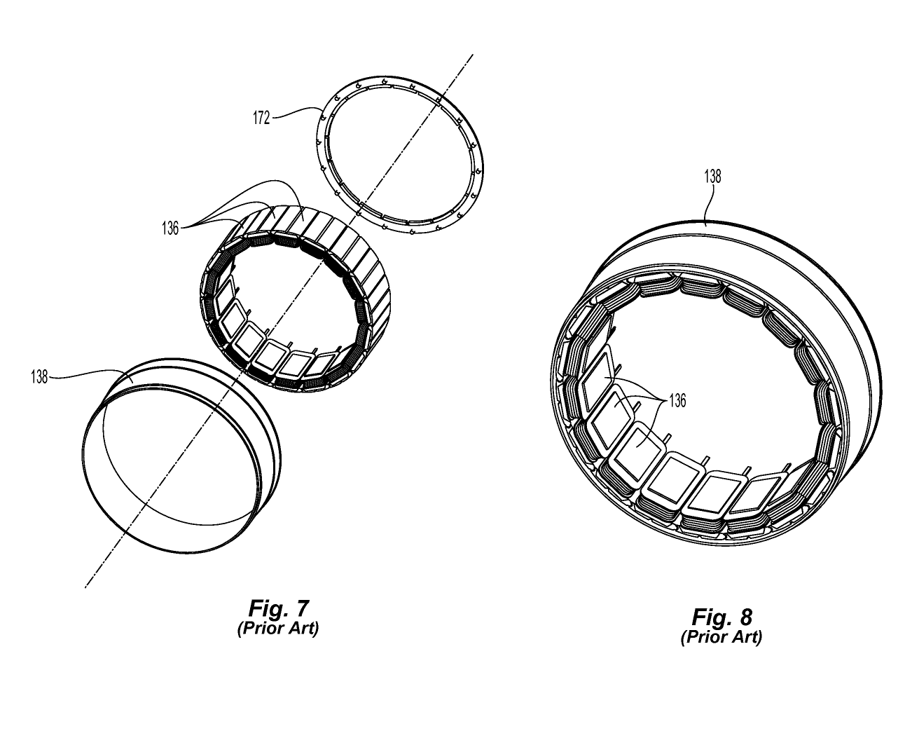

An electric machine 20 having a housing 22, a rotor assembly 24 and a stator assembly 26 is shown in FIG. 5. The illustrated electric machine 20 is a three-phase brushless AC motor/generator suitable for use in hybrid or electric vehicles. The segmented core assembly and method of assembling described herein, however, can be adapted for use in any type of electric machine that can be manufactured with a segmented core. Rotor assembly 24 includes a core 25 in which are mounted a plurality of permanent magnets. The rotor core 25 is mounted on a hub that receives a shaft. The rotor hub and shaft are not illustrated in FIG. 5. Rotor 24 is received within the central bore 34 of stator assembly 26.

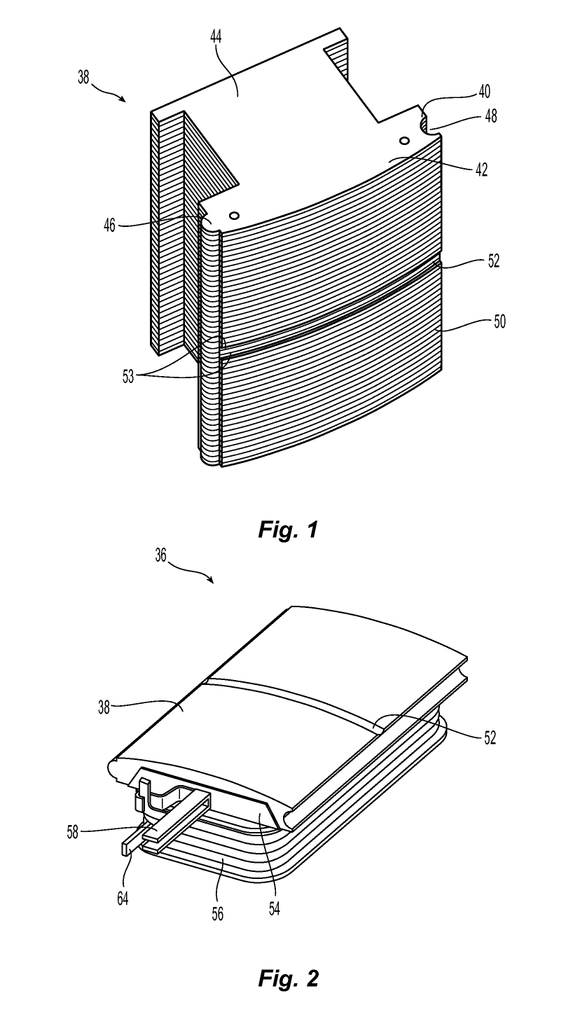

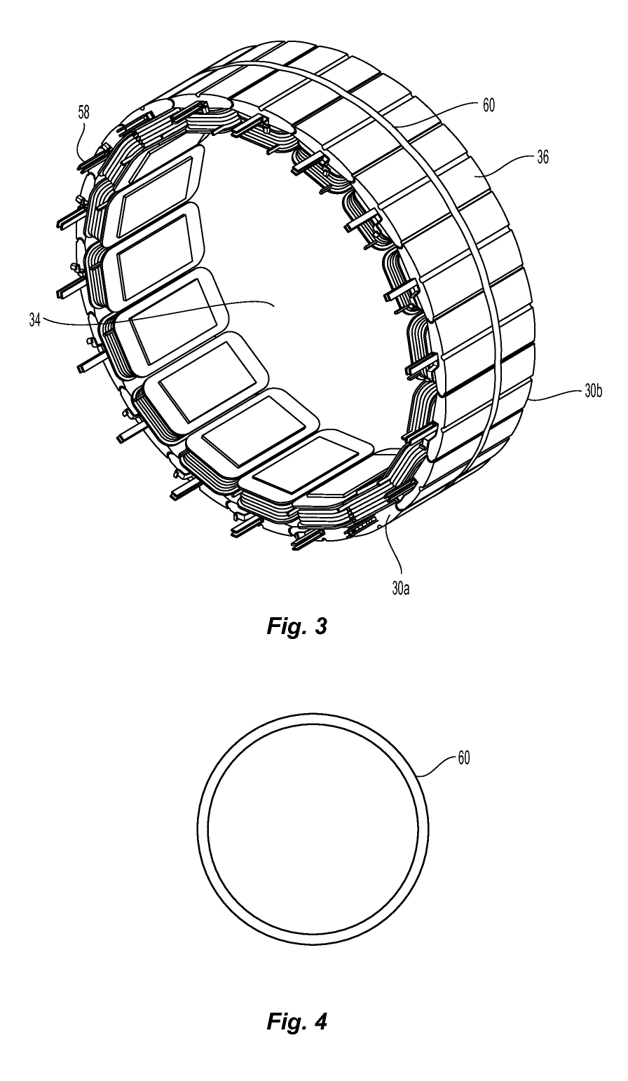

Stator assembly 26 is shown in FIG. 3 and is formed out of a plurality of individual stator segments 36 and defines an axis 28. An individual stator segment 36 is shown in FIG. 2 while FIG. 1 illustrates the core 38 of an individual stator segment 36. Segment core 38 is formed out of a plurality of stacked laminations 40. Laminations 40 are stamped out of sheet metal, e.g., in a progressive die, and then joined together to form segment cores 38. The use and stamping of sheet metal laminations to form stator and rotor cores is well-known in the art. Laminations 40 may be secured together in any one of a variety of methods. For example, laminations 40 may be joined by welding, adhesives, bonding, interlocking features or other means known in the art.

In the illustrated embodiment, each of the laminations 40 includes a circumferentially extending main body or yoke portion 42 and pole or tooth 44 that projects radially inwardly from yoke portion 42. A tongue 46 and a groove 48 are located on opposite ends of main body 42 and engage and interfit with similar features on adjacent core segments 38 when the core segments are secured together. In the illustrated embodiment, core segments 38 are arranged in an annular ring that defines a central bore 34, however, alternative embodiments may use a belt member to secure core segments to form differently shaped configurations.

The edges of laminations 40 form an outer radial surface 50 which includes a recess 52 for receiving belt member 60 as discussed in greater detail below. In the illustrated embodiment, the laminations forming segment core 38 have two different configurations. A majority of the laminations have a configuration similar to the top lamination shown in its entirety in FIG. 1 and a few of the laminations, identified with reference numeral 53 in FIG. 1, have an additional band of material removed to form recess 52. A person having ordinary skill in the art will recognize that a progressive die can be employed to stamp and stack the laminations 40 forming core 38.

After securing laminations 40 into a stack to form core segment 38, a coil isolator 54 is formed on those portions of core segment 38 that will support the winding. In the illustrated embodiment, it is pole 44 which supports the winding. Coil isolator 54 is an electrically non-conductive material which provides electrical insulation and prevents shorting between the windings and the sheet metal laminations 40. Coil isolator 54 may be formed out of a polyphenylene sulfide (“PPS”) material.

After forming the coil isolator 54 on pole 44, a length of copper winding wire is wound about pole 44 to form coil 56. A connector 58 may be advantageously secured to stator segment 36 and conductively coupled to one end of the coil 56. In the illustrated embodiment, connector 58 is secured to stator segment 36 with the material forming coil isolator 54. After installing coil isolators 54, coils 56 and connectors 58 on a plurality of core segments 38, the resulting stator segments 36 can be positioned in a ring. When positioned in a ring, the tongue 46 and groove 48 of each stator segment 36 will be engaged with a corresponding groove 48 or tongue 46 on an adjacent stator segment 36. A belt member 60 that substantially circumscribes the ring of segments 36 is then installed on the segments 36 to secure the segments 36 in the ring shape in which they have been positioned. As used herein, a belt member simply refers to something capable of substantially encircling a group of core segments to hold them together.

In the illustrated embodiment, belt 60 is a circular steel ring that fits within recess 52 and completely encircles stator segments 36. Stator segments 36 define first and second opposite axial ends 30a, 30b of stator core assembly 26 wherein ends 30a, 30b are separated by an axial distance 32. Belt 60 defines an axial height 60a which is less than axial distance 32. The illustrated stator segments 36 have an axial length 32 of about 80 mm. A steel belt 60 having a radial thickness of about 1 to 1.5 mm and an axial height 60a of about 3 to 4 mm is suitable for the illustrated stator assembly 26. In other words, a belt having an axial dimension 60a which is less than or equal to approximately 5% of the axial length 32 of the segment core can, depending on materials and core configuration, be sufficient to secure stator segments 36. Belt 60, however, is not limited to the dimensions or configuration of the illustrated embodiment.

Because belt member 60 has an axial height 60a that is less than axial distance 32, when belt member 60 engages core segments 38, it will only engage a selected few, e.g., laminations 53 in the illustrated embodiment, of the total number of stacked laminations which form core segment 38.

When installing belt 60, belt 60 is heated to expand the size of belt 60 and allow it to be slipped over the outer radial surfaces 50 of segments 36. It may also be advantageous to cool segments 36 to shrink the size of segments 36 during the installation of belt 60. After segments 36 and belt 60 reach a common temperature, belt 60 will fit snugly within recess 52. Advantageously, belt 60 fits entirely within recess 52 and does not extend radially outwardly beyond surface 50 to thereby facilitate the insertion of stator assembly 26 into housing 22.

While the illustrated belt 60 is made out of a steel material, alternative materials may also be used to form belt 60 such as aluminum, plastic or other suitable materials. Metal materials can be advantageous due to their strength and their high thermal conductivity. Materials with high thermal conductivity can be beneficial by facilitating the transfer of heat from the core segment 38 during operation of the electric machine. Belt 60 advantageously closely fits recess 52 whereby heat transfer from core segments 38 to housing 22 is facilitated.

It is also noted that the belt could initially be a linear length of material that is wrapped about segments 36 formed into a ring and then joined to itself, e.g., by tack welding. In still another embodiment, the belt could substantially, but not completely, circumscribe the ring of segments 36. For example, opposite ends of the belt could be secured to a common segment 36 after the length of the belt was wrapped about the segments 36 while leaving a gap between the opposite ends of the belt.

Still other modifications to the illustrated embodiment may be employed. For example, recess 52 could be omitted with belt 60 being positioned on outer surface 50. It is further noted that while the illustrated embodiment uses only a single belt 60 that is located proximate the midpoint between opposite axial ends 30a, 30b of the core, other embodiments might employ a plurality of belts 60. For example, a core having a longer axis and a more elongate shape than the illustrated stator assembly might beneficially employ a plurality of belts 60 spaced along the axial length of the core.

As can be seen in the Figures, the illustrated belt member 60 is axially disposed entirely between the first and second axial ends 30a, 30b of the core assembly 26. More particularly, it is noted that the illustrated embodiment has a belt member 60 disposed between and spaced from the first and second axial ends 30a, 30b of core assembly 26. As mentioned above, when using a single belt member 60, it will generally be advantageous for the belt member 60 to be disposed substantially equidistantly between the first and second axial ends 30a, 30b.

After stator segments 36 have been secured together with belt 60, a varnish 62 is applied to the assembled ring of segments 36. The varnish is a non-conductive material that coats the wire forming coil 56 to provide a layer of electrical insulation. It also advantageously securely encapsulates the wire of coil 56 to prevent relative movement of individual segments of coil 56 and movement of coil 56 relative to core segment 38 as can be understood with reference to FIG. 6. Polyester and polyurethane are two commonly used varnish materials. The varnish may be applied by a trickle or dip process, by vacuum pressure impregnation (“VPI”) or other suitable method.

In the illustrated embodiment, the varnish applied to outer surface 50 is removed by machining or other suitable process to improve the transfer of heat from core segments 38 to housing 22. It may also be necessary to remove varnish from a portion of connector 58 and the other end 64 of coil 56 when forming electrical connections between coil 56 and bus bar assembly 72 during the installation of stator assembly 26 into electric machine 20. The use of bus bar 72 to electrically couple the windings of an electric machine is well-known to those having ordinary skill in the art.

After varnishing stator assembly 26 and performing any further step necessary prior to installation in housing 22, e.g., removal of varnish from selected areas or attachment of additional electrical connectors or other components, the stator assembly 26 will be completed. Stator assembly 26 is then installed in housing 22 by sliding it therein. To facilitate the insertion of stator assembly 26 into housing 22, housing 22 may be heated and/or stator assembly 26 may be cooled to increase the size of housing 22 relative to stator assembly 26. Once housing 22 and stator assembly 26 have returned to a common temperature, stator assembly 26 will be firmly secured within housing 22. Housing 22 may be made out of steel, aluminum or other suitable material.

The illustrated housing 22 includes fluid channels 66 through which a liquid coolant, e.g., water or oil, is circulated. The coolant is used to remove heat generated by the operation of electric machine 20. The direct engagement of surface 50 of laminations 40 with interior surface 68 of housing 22 facilitates the transfer of heat from laminations 40 to housing 22 from which it can be removed by the coolant circulating in channels 66. It is advantageous to have surface 50 of laminations 40 directly engage surface 68 without a layer of varnish or intermediate sleeve interposed between surfaces 50 and 68 to promote the transfer of heat. Varnish will typically have a lower heat transmissive value than metal materials and thus inhibits the transfer of heat. The use of a sleeve that extends the full axial length of the stator core creates two additional interfaces which can inhibit the transfer of heat even if the sleeve is formed out of a metal material.

The use of a belt member 60 having a relatively small axial dimension promotes the transfer of heat from the stator core to housing 22 by maximizing the surface area of surfaces 50 in direct contact with surface 68 of housing 22. When belt member 60 will remain permanently installed on the stator core assembly, it is advantageous to use a thermally conductive belt member 60, e.g., a metallic belt member, disposed in a recess 52. The use of a recess 52 allows for contact between surfaces 50 and 68 and also allows belt member 60 to contact both the laminations of the core assembly and surface 68. The use of a metallic belt member 60 facilitates the transfer of heat from the core assembly through belt member 60 to housing 22. As the axial height of belt member 60 increases, the value of using of a metallic belt capable to efficiently transferring heat also increases. It is additionally noted, that if belt member 60 is removed during installation of the core assembly, it is advantageous to omit recess 52 to thereby increase the surface area of the core assembly in direct contact with surface 68 of housing 22.

It is also noted that housing 22 may have various features 70 which are used to mount other parts of the electric machine, e.g., electrical connectors, or to mount the electric machine 20 to a vehicle. Generally, it will be advantageous if such features 70 do not have a layer of varnish disposed thereon. By using belt 60, stator assembly 26 can be efficiently varnished before installation in housing 22, and thereby avoid the application of varnish to features 70. Belt 60 also allows stator assembly 26 to be secured into a ring prior to insertion into housing and thereby eases the insertion of stator assembly 26 into housing 22.

A method of manufacturing electric machine 20 will now be discussed. First, laminations 40 are stamped. Laminations 40 are then stacked and secured to form stator core segments 38. Coil isolators 54 are then formed on stator core segments 38. After forming coil isolators 54 on segments 38, a coil 56 is wound on each of the segments 38. A plurality of the resulting stator segments 36 with coils 56 are then arranged in a ring and a belt 60 is installed around the stator segments 36 to secure the stator segments 36 together. In the illustrated embodiment, stator segments 36 are secured in a ring-shaped stator assembly 26.

The stator assembly 26 is then varnished. The varnished stator assembly 26 is then transported to an installation station and installed in an electric machine assembly 20 and coupled with a rotor assembly 24. For example, the stator assembly 26 could be installed into a housing 22. After installation of stator assembly 26 in housing 22, rotor assembly 24 and the remainder of the electric machine is then installed. This method provides several advantages. For example, installation of belt 60 prior to varnishing the stator assembly 26 facilitates the efficient varnishing of stator assembly 26 allowing it to be varnished in a single varnishing step while minimizing the amount of varnish that must be removed prior to completing the assembly of electric machine 20. The use of belt 60 also allows stator assembly 26 to be more easily handled and transported prior to its installation in the electric machine assembly.

While the above-described manufacturing method provides numerous advantages, alternative methods of employing a belt 60 can also be beneficially employed. For example, rotor assembly 24 and other components of the electric machine 20 could be coupled with the stator assembly 26 prior to installing stator assembly 26 in housing 22. In still other embodiments, the stator segments 36 can be individually varnished prior to securing the stator segments 36 into a ring with belt 60. In embodiments where stator segments 36 are individually varnished, the use of belt 60 allows the stator assembly 26 to be easily handled and transported prior to installation in the electric machine 20.

It is noted that belt 60 can remain in the fully assembled electric machine 20 or be removed as the core assembly is inserted in the housing. For belts which will remain in the electric machine, the properties of the electric machine and its intended application will determine appropriate materials for the belt 60. Generally, it will be desirable to form belt 60 out of a metal material when belt member 60 will remain in the fully assembled electric machine 20. When belt 60 will be removed during installation of the core assembly into the housing, alternative materials for belt 60 may be more advantageous. For example, after partially inserting segments 36 into housing 22 and before belt 60 entered the interior of housing 22, a polymeric belt 60 could be easily removed by cutting it during the insertion of the core assembly into the housing. In still another embodiment, segments 36 are not provided with a recess 52 and belt 60 is slid off of the segments 36 during the installation of the segments 36 into the housing 22.

Thus, belt members may advantageously take the form of metallic belts, polymeric belts and belts formed out of elastically deformable materials as well as any other material having the necessary physical properties. For example, an elastically deformable belt could be positioned on the ring of segments 36 without heating the belt or cooling the segments 36 and removed from the ring of segments 36 during installation of the ring of segments 36 into housing 22. In still another embodiment, the belt might be an initially linear member securable to itself in a manner similar to an electrical tie. Such electrical ties are well known and have an elongate length which defines a plurality of spaced teeth similar to a rack in a rack and pinion arrangement. At one end a connecting head defines a slot through which the opposite end can be inserted to form a loop. Within the slot, a resilient engagement member allows the teeth to be pulled in a direction that reduces the size of the loop but prevents the teeth from being pulled in the opposite direction enlarging the loop. The plastic, i.e., polymeric, tie could then be cut off and removed from the segments 36 during the installation of the ring of segments into the housing.

The material used to form the belt would need to have the strength and material properties necessary to keep segments 36 secured in a ring during the varnishing and installation procedures if the varnishing process was conducted after securing segments 36 with the belt. If the individual segments 36 are varnished prior to securing the segments 36 into a ring with the belt, the material used to form the belt will not have to withstand the varnishing process. For example, such a belt could be beneficially employed as an assembly aid during the installation of the stator assembly into housing 22.

While the illustrated embodiment depicts the use of a belt 60 with a segmented stator assembly, the use of such a belt could also be employed with a segmented rotor assembly. It is also noted that the use of a belt could also be employed with core segments that are secured together with coils located on their radial outer surface and wherein the segmented core does not have a central bore but is located within a central bore of the other corresponding stator or rotor.

While this invention has been described as having an exemplary design, the present invention may be further modified within the spirit and scope of this disclosure. This application is therefore intended to cover any variations, uses, or adaptations of the invention using its general principles.

What is claimed is:

1. An electric machine comprising:
a stator assembly and a rotor assembly wherein at least one of the assemblies includes a core; and
the core comprises a plurality of core segments defining an axial length, the core segments being secured together in a core assembly with at least one belt member which substantially circumscribes the plurality of core segments and has an axial dimension that is less than the axial length of the core segments, the core assembly defining first and second axial ends and the belt member being disposed between and spaced from the first and second axial ends of the core assembly.

2. The electric machine of claim 1 wherein the at least one belt member is a single belt member that is disposed substantially equidistantly between the first and second axial ends.

3. The electric machine of claim 1 wherein each core segment comprises at least one pole and wherein a wire coil is wrapped about each of the at least one poles.

4. The electric machine of claim 3 wherein each core segment has a single pole extending from a circumferentially extending yoke portion, each of the yoke portions being engaged with the yoke portions of adjacently positioned core segments when the plurality of core segments are secured together in the core assembly.

5. The electric machine of claim 1 wherein each of the core segments is formed out of a plurality of stacked lamina and wherein the belt member engages only selected ones of the plurality of stacked lamina.

6. The electric machine of claim 5 wherein the selected ones of the plurality of stacked lamina define a recess for receiving the belt member.

7. The electric machine of claim 1 wherein the belt member fully encircles the plurality of core segments when secured together in the core assembly.

8. The electric machine of claim 1 wherein the belt member is formed out of a metal material.

9. The electric machine of claim 1 wherein the belt member is formed out of a polymeric material.

10. The electric machine of claim 1 wherein the axial height of the belt member is no more than approximately 5% of the axial distance between the first and second axial ends.

11. The electric machine of claim 10 wherein the core assembly is a stator core and defines a central bore for receiving the rotor assembly;
wherein the at least one belt member is a single belt formed out of a metal material, completely encircles the plurality of core segments when secured in the core assembly, and is disposed substantially equidistantly between the first and second axial ends;
wherein each of the core segments has a single pole extending from a circumferentially extending yoke portion, each of the yoke portions being engaged with the yoke portions of adjacently positioned core segments when the plurality of core segments are secured in the core assembly and wherein a wire coil is wrapped about each of the poles;
wherein each of the core segments is formed out of a plurality of stacked lamina and selected ones of the plurality of lamina define a recess for receiving the belt member; and
a housing member defining a fluid passage for circulating a coolant, the core assembly being disposed within the housing member wherein an outer radial surface of each of the yoke portions is engaged with the housing member to thereby transfer heat from the core assembly to the housing.

12. A core assembly for an electric machine:
a plurality of core segments defining an axial length, the core segments being secured together in a core assembly with a belt member which substantially circumscribes the plurality of core segments and has an axial dimension that is less than the axial length of the core segments; and
wherein the core assembly defines first and second axial ends and the belt member is axially disposed entirely between the first and second axial ends of the core assembly.

13. The core assembly of claim 12 wherein the core assembly is a stator core that defines a central bore for receiving the rotor assembly and wherein the at least one belt member is a single belt member that is disposed substantially equidistantly between the first and second axial ends.

14. The core assembly of claim 13 wherein each core segment has a single pole extending from a circumferentially extending yoke portion wherein a wire coil is wrapped about each of the poles and wherein each of the yoke portions is engaged with the yoke portions of adjacently positioned core segments when the plurality of core segments are secured together in the core assembly; and
wherein each of the core segments is formed out of a plurality of stacked lamina and selected ones of the plurality of stacked lamina define a recess for receiving the belt member.

15. A method of manufacturing an electric machine having at least one segmented core, said method comprising:
forming a plurality of core segments, each of the core segments being formed by stacking a plurality of lamina;
winding a wire coil about each of the core segments;
securing the plurality of core segments in a core assembly with a belt member that substantially circumscribes the plurality of core segments; the core assembly defining first and second axial ends, the belt member being axially disposed entirely between the first and second ends and having an axial height less than an axial distance between the first and second ends; and
installing the core assembly in a housing member after securing the plurality of core segments with the belt member.

16. The method of claim 15 further comprising the step of applying a varnish to the core assembly after securing the plurality of core segments together with the belt member.

17. The method of claim 16 further comprising:
removing varnish from the outer radial surfaces of the core segments;
providing the housing member with a fluid channel for circulating a coolant; and
installing the core assembly in the housing member with the outer radial surface of the core segments engaged with the housing member.

18. The method of claim 15 wherein the belt member is positioned on the core assembly after completing assembly of the electric machine.

19. The method of claim 15 wherein the belt member is removed from the core assembly during the installation of the core assembly into the housing member.

20. The method of claim 15 wherein the core assembly is a stator core and has a central bore and wherein each of the core segments define a circumferentially extending yoke portion having a single pole extending radially therefrom, the wire coil of each core segment being wound about the pole, the method further comprising:
engaging the yoke portions of each of the core segments with the yoke portions of adjacent core segments when securing the core segments with the belt member;
positioning the belt member in a recess defined by an outer radial surface of the plurality of core segments and circumscribing the core assembly;
providing the housing member with a fluid channel for circulating a coolant;
installing the core assembly in the housing member with the outer radial surface of the core segments engaged with the housing member; and
positioning a rotor assembly in the central bore.
